(19) United States
(12) Patent Application Publication
(10) Pub. No.: US 2011/0314697 A1
(43) Pub. Date: Dec. 29, 2011

(54) ANTI-SLIP FABRIC AND INSOLE USING THE SAME

(75) Inventor: Ching-Bing CHANG, Taichung City (TW)

(73) Assignee: KUN HUANG ENTERPRISE CO., LTD., Miaoli (TW)

(21) Appl. No.: 13/156,797

(22) Filed: Jun. 9, 2011

(30) Foreign Application Priority Data
Jun. 28, 2010 (TW) 99121085
Jun. 28, 2010 (TW) 99212243

(51) Int. Cl. A43B 13/38; B32B 3/00

(52) U.S. Cl. 36/44; 428/156

(57) ABSTRACT

An anti-slip fabric includes a fabric substratum on which a plurality of anti-slip posts are arranged. Each anti-slip post has a body fixedly connected with the fabric substratum, and a head coaxially connected with the body and having a diameter equal to or greater than that of the body. The anti-slip fabric can be mounted on an insole substratum to form an anti-slip insole. As a result, the anti-slip fabric or insole can provide a sufficient anti-slip effect, which will not easily fail even though the surface of the anti-slip fabric is water wetted to cause friction deterioration.

### BACKGROUND OF THE INVENTION

1. Field of the Invention

The present invention relates generally to a fabric and more particularly, to an anti-slip fabric and an insole using the same.

2. Description of the Related Art

Generally, commercially available anti-slip fabrics are composed of a flat fabric substratum on which an anti-slip layer, such as a plastic layer, a silicon film or a polyester foam layer, is bonded by a spray coating process. By means of the anti-slip characteristic inherently provided by the plastic, silicon or polyester foam to enhance the friction force exerting on an object that contacts the anti-slip layer, the anti-slip effect of the conventional anti-slip fabrics can be achieved.

However, the friction force exerting on the object contacting the anti-slip layer will drop when the surface of the anti-slip layer of the conventional anti-slip fabric is water wetted, which in turn adversely affects the anti-slip effect provided by the conventional anti-slip fabric. In addition, the material from which the object contacting the anti-slip layer is made will affect the anti-slip effect that the conventional anti-slip fabric can provide. For example, the anti-slip effect that the conventional anti-slip fabric provides to an object having a smooth contact surface will be better than the anti-slip effect to a doll having a cotton or knitting fabric.

On the other hand, the socks worn on user's feet may be wetted by foot sweat when the user wearing the socks with his/her shoes is doing exercise or takes a long walk. If the user who wears the wetted socks keeps doing exercise or walking speedily, the user's foot may slip relative to his/her shoe due to the ground that the friction between the wetted sock and the insole becomes weak. Slip of foot inside a shoe may cause foot injury to the user or a miss shot for a football player. One effective solution to this problem is to add an anti-slip insole into a shoe.

FIG. 8 shows a conventional anti-slip insole 80, which is composed of an insole substratum 82 on which a plurality of hook members 84 each having a hook end 841 are provided. By means of hooking the hook ends 841 of the hook members 84 with the user's sock, the user's foot will not easily slip in his/her shoe so as to prevent the user's foot from possible injury. However, the hook ends 841 of the hook members 84 tend to be strongly hooked with user's sock, resulting in a difficult movement of user's foot when the user puts on or takes off his/her shoe.

### SUMMARY OF THE INVENTION

The present invention has been accomplished in view of the above-noted circumstances. It is therefore one objective of the present invention to provide an anti-slip fabric, which utilizes an anchor mechanism to realize the anti-slip function, such that the anti-slip effect will not be easily deteriorated due to water.

Another objective of the present invention is to provide an anti-slip insole using the above-mentioned anti-slip fabric.

To achieve the above-mentioned objectives, the anti-slip fabric provided by the present invention comprises a fabric substratum on which a plurality of anti-slip posts are arranged. Each anti-slip post has a body fixedly connected with the fabric substratum, and a head coaxially connected with the body and having a diameter equal to or greater than that of the body. By means of anchoring the heads of the anti-slip posts into an object containing a cotton or knitting fabric, the anti-slip fabric can provide a desired anti-slip effect to the object.

Preferably, the diameter of the head is greater than that of the body of each of the anti-slip posts.

In the anti-slip fabric of the present invention, the anti-slip posts may be made from Nylon or polyethylene.

In the anti-slip fabric of the present invention, the anti-slip posts may have various configurations. Similarly, the cross-sections of the heads of the anti-slip posts may have various geometric shapes including, but not limited to, triangular, rectangular, pentagonal and polygonal shapes. Preferably, the head of the anti-slip post has a part that is curved in configuration, such that water drop will not easily stay on the head. Therefore, the anti-slip effect provided by the anti-slip fabric of the present invention will not be easily deteriorated due to water. More preferably, the head of the anti-slip posts has a spherical shape so as to prevent the object anchored with the anti-slip fabric from damage due to the anchored engagement. In addition, the contained angle between the body of the anti-slip post and the fabric substratum may be greater than 0 degree and smaller than 180 degrees. Preferably, the anti-slip posts uprightly extend from the fabric substratum.

In the anti-slip fabric of the present invention, the anti-slip posts may have a same or different height relative to each other, may be evenly or unevenly arranged on the fabric substratum, and may have a same or different shape in their heads. For example, a region of the fabric substratum may be arranged with a plurality of anti-slip posts in such a way that the amount of which is greater than the amount of the anti-slip posts arranged on the residual region of the fabric substratum. Further, the heights of the anti-slip posts arranged on a same region may be different or the same. Furthermore, the anti-slip posts may be evenly arranged on the fabric substratum with a different or same height and a different or same shape in their heads.

In the anti-slip fabric of the present invention, the head and the body of the anti-slip post may be integrally formed with each other and the anti-slip posts and the fabric substratum may be integrally formed.

Preferably, the anti-slip fabric of the present invention is formed by molding. On the other hand, the anti-slip fabric of the present invention, which has anti-slip posts each composed of integrally formed body and head, may be formed by the steps of forming posts having a uniform diameter on the fabric substratum and then heat melting the top ends of the posts by fire or any suitable heating way to form the head having a diameter greater than that of the residual part of each post.

In another aspect, the insole provided by the present invention comprises an insole substratum on which the above-mentioned anti-slip fabric is attached. Specifically speaking, the fabric substratum is bonded on the insole substratum. By means of anchoring the heads of the anti-slip fabric into an object, such as a sock and the like, the anti-slip effect of the insole of the present invention can be realized.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a part of an anti-slip fabric according to a preferred embodiment of the present invention;

FIG. 2 is a lateral side view of the anti-slip fabric of the preferred embodiment of the present invention, showing that the heights and head configurations of the posts are the same, the posts are evenly arranged on the fabric substratum and the diameter of the heads of the posts is greater than that of the bodies of the posts;

FIG. 3 is a lateral side view of the anti-slip fabric according to another preferred embodiment of the present invention, showing that the heights of the posts are the same, the posts are evenly arranged on the fabric substratum and the heads of the posts have various configurations;

FIG. 4 is a lateral side view of the anti-slip fabric according to still another preferred embodiment of the present invention, showing that the posts are evenly arranged on the fabric substratum with various heights and the heads of the posts have various configurations;

FIG. 5 is a lateral side view of the anti-slip fabric according to still another preferred embodiment of the present invention, showing that the heights and head configurations of the posts are the same, the posts are evenly arranged on the fabric substratum, and the diameter of the heads of the posts is equal to that of the bodies of the posts;

FIG. 6 is a perspective view of an insole according to a preferred embodiment of the present invention;

FIG. 7 is a schematic drawing showing that the insole of FIG. 6 is inserted into an inside of a shoe; and

FIG. 8 is a lateral side view of an anti-slip insole according to a prior art.

### DETAILED DESCRIPTION OF THE INVENTION

It will be appreciated that in the preferred embodiments to be detailed described hereunder, the same reference numeral represents the same or similar part.

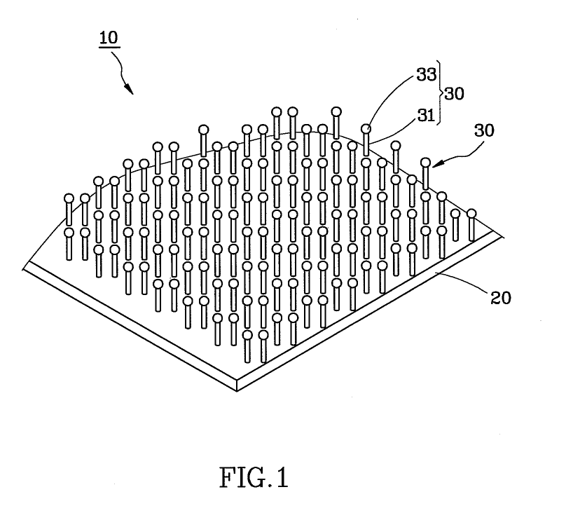

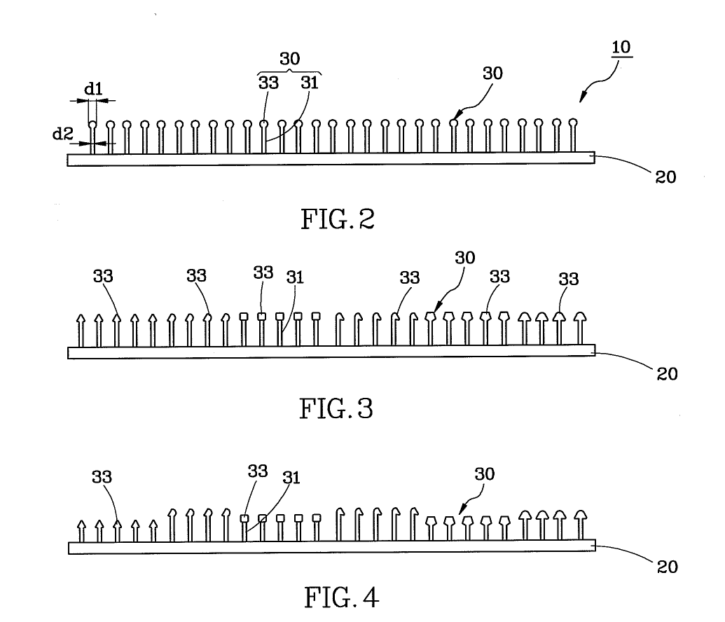

As shown in FIGS. 1-2, the anti-slip fabric 10 provided by a preferred embodiment of the present invention mainly comprises a fabric substratum 20 and a plurality of anti-slip posts 30.

The fabric substratum 20 is made from Nylon and has a flat shape.

Each anti-slip posts 30 is made form Nylon and has a body 31 fixedly connected with the surface of the fabric substratum 20, and a head 33 integrally and coaxially connected with the body 31. The head 33 has a diameter d1 greater than the diameter d2 of the body 31. In this embodiment, the heads 33 of the anti-slip posts 30 have a spherical shape. Practically, the shape of the head 33 is not limited to sphere. For example, the cross-section of the head 33 of the anti-slip post 30 can have a different shape, such as a triangular, rectangular, pentagonal or polygonal shape as shown in FIG. 3. Alternatively, the cross-section of the head 33 of the anti-slip post 30 can have a part with a curved shape.

In practice, the anti-slip fabric 10 is made by molding, such that the fabric substratum 20 and the anti-slip posts 30 are integrally formed.

When an object, such as a doll containing a cotton or knitting fabric, is put on the anti-slip fabric 10 of the present invention, the heads 33 of the anti-slip posts 30 can be anchored into the aforesaid cotton or knitting fabric to further prevent the object having the cotton or knitting fabric from slip from the anti-slip fabric 10 of the present invention. On the other hand, since the heads 33 of the anti-slip posts 30 have a substantially spherical shape, the object won't be damaged by the anchored engagement of the heads 33.

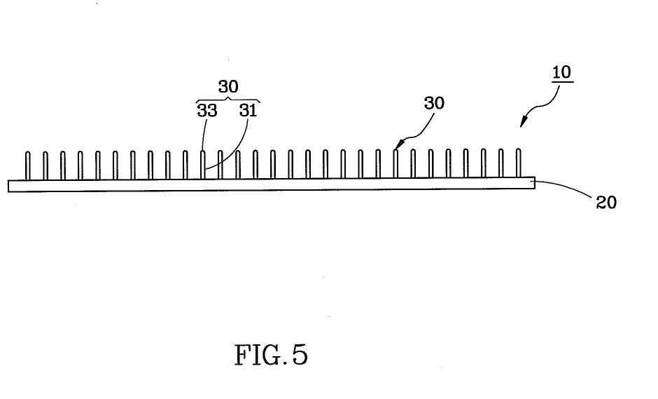

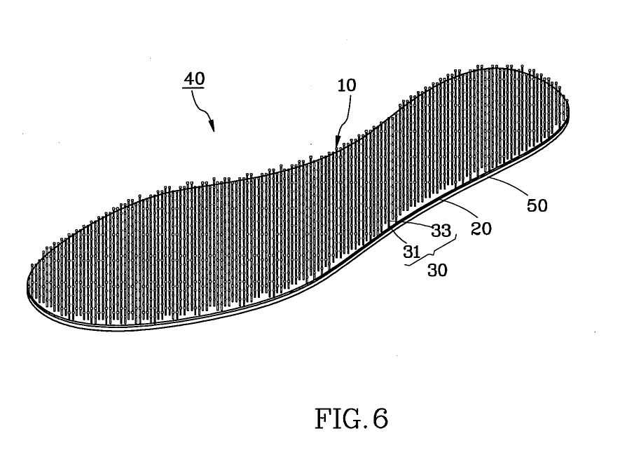

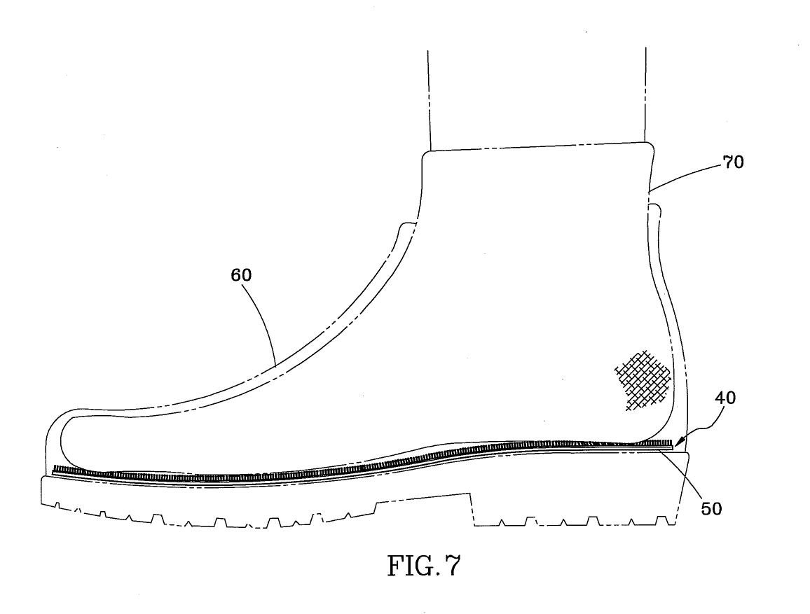

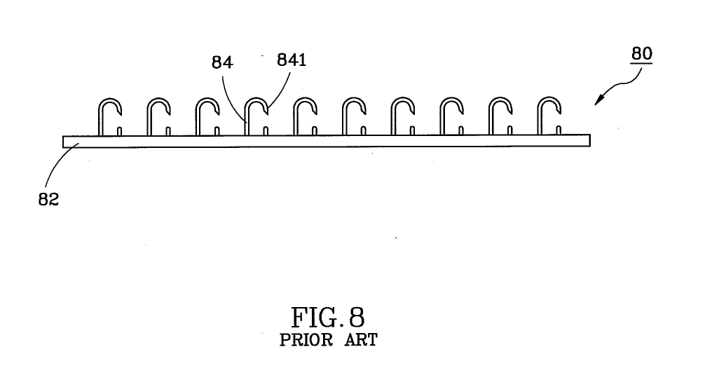

It is to be understood that the anti-slip posts 30 can be evenly arranged on the fabric substratum 20 with a same or different height and/or configuration, as shown in FIGS. 3-4. Specifically speaking, as shown in FIGS. 1-2, the posts 30 are evenly arranged on the fabric substratum 20 and have a same height with a same head configuration. Further, as shown in FIG. 3, the anti-slip posts 30 are evenly arranged on the fabric substratum 20 with a same height; however, the heads 33 of the anti-slip posts 30 can be classified into several groups each having a specific configuration. Furthermore, as shown in FIG. 4, the anti-slip posts 30 are evenly arranged on the fabric substratum 20; however, they can be classified into several groups having a specific height and head configuration. In practice, the anti-slip posts 30 can be evenly or unevenly arranged on the fabric substratum 20. For example, a region of the fabric substratum 20 can be arranged with a relatively greater amount of the anti-slip posts 30 and the residual region of the fabric substratum 30 can be arranged with a relatively lesser amount of the anti-slip posts 30. In addition, as shown in FIG. 5, the anti-slip posts 30 are evenly arranged on the fabric substratum 20 with a same height; however, the heads 33 of the anti-slip posts 30 have a diameter equal to that of the bodies 31 of the anti-slip post 30. In conclusion, the amount, head configuration and height of the anti-slip posts 30 can be varyingly designed according to an actual need, and those variations should be covered within the scope of the present invention.

In the above-mentioned preferred embodiments, the anti-slip posts 30 are designed to uprightly extend from the fabric substratum 20; however, the contained angle between the anti-slip post 30 and the fabric substratum 20 is not limited to the aforesaid right angle. In practice, the contained angle can designed to be greater than 0 degree and smaller than 180 degrees.

It will be appreciated that the material that the fabric substratum 20 and the anti-slip posts 30 are made from is not limited to the above-mentioned Nylon. Plastic material, such as polyethylene, can be used to make the fabric substratum 20 and the posts 30. In addition, the method of making the anti-slip fabric 10 of the present invention is not limited to the above-mentioned molding process. For example, it can be made by the steps of penetrating the fabric substratum 20 with a plurality of short Nylon threads (not shown in the drawings) in such a way that the two ends of each thread are suspended above the surface of the fabric substratum 20 so as to form on the surface of the fabric substratum 20 a plurality of upright posts with a uniform diameter, and then speedily firing the top ends of the upright posts to heat melt the top ends of the upright extending Nylon posts into spheres so as to form the aforesaid anti-slip posts each having a head and a body integrally formed with each other. It is to be understood that the aforesaid method of making the anti-slip fabric is just an exemplary embodiment; any suitable method that can make the anti-slip fabric 10 having the above-disclosed configurations of the anti-slip posts 30 can be used.

The anti-slip fabric 10 of the present invention can be applied to many fields including, but not limited to, shoe manufacturing field. For example, the anti-slip fabric 10 of the present invention can be used in manufacturing an anti-slip insole. Specifically speaking, as shown in FIG. 6, an insole 40 provided by a preferred embodiment of the present invention is composed of an insole substratum 50 and an anti-slip fabric 10 bonded on the insole substratum 50.

The insole substratum 50 has a substantially flat shape. The anti-slip fabric 10 has a fabric substratum 20 on which anti-slip posts 30 are evenly arranged, as shown in FIG. 1. The fabric substratum 20 of the anti-slip fabric 10 is bonded on the insole substratum 50 such that the upright extending anti-slip posts 30 can provide the anti-slip effect for the insole 40.

It will be appreciated that the anti-slip fabrics 10 disclosed in FIGS. 1 and 3-5 can be used for the insole 40. Particularly, the distribution of the anti-slip posts 30 may be determined according to the foot structure. For example, the anti-slip posts 30 can be unevenly arranged in such a manner that the region of the insole, which corresponds in location to the main weight bearing portion of the foot, is provided with a relatively larger amount of anti-slip posts 30, and the region of the insole, which corresponds in location to the arch of foot, is provided with a relatively smaller amount of anti-slip posts 30. In manufacturing, the anti-slip fabric 10 having the anti-slip posts 30, which is made by a molding process in advance, is adhesively bonded on the insole substratum 50 by glue, and than the laminate including the insole substratum 50 and the anti-slip fabric 10 is cut into a predetermined shape so as to form the anti-slip insole 40 of the present invention.

When the anti-slip insole 40 is in use, the anti-slip insole is inserted into the inside of a shoe 60, such that the heads 33 of the anti-slip posts 30 can be anchored into a sock worn on the foot of the user so as to prevent the user's foot from slip inside the shoe 60. In addition, since the heads 33 of the anti-slip posts 30 can be designed having a substantially spherical shape, the sock won't be damaged by the anchored engagement of the heads 33.

In conclusion, since the anti-slip fabric of the present invention is provided with the anti-slip posts each having a head with a diameter equal to or greater than that of the body thereof, the anti-slip effect can be achieved by the anchor engaging feature of the heads. In addition, the anti-slip effect provided by the anti-slip fabric will not easily drop due to water. On the other hand, the insole adopting the anti-slip fabric of the present invention can provide sufficient anti-slip effect to the sock worn on the user's foot and the anti-slip effect will not be easily affected by user's foot sweat. Further, the anti-slip insole of the present invention will not strongly anchor the user's sock, such that the anti-slip insole of the present invention has an advantage of enabling the user to conveniently put on and take off the shoe compared to the prior art anti-slip insole.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An anti-slip fabric comprising:
a fabric substratum, and
a plurality of anti-slip posts each having a body fixedly connected with the fabric substratum, and a head coaxially connected with the body and having a diameter equal to or greater than a diameter of the body.

2. The anti-slip fabric as claimed in claim 1, wherein the diameter of the head is greater than the diameter of the body of each of the anti-slip posts.

3. The anti-slip fabric as claimed in claim 1, wherein the anti-slip posts are made from Nylon or polyethylene.

4. The anti-slip fabric as claimed in claim 1, wherein the head of each of the anti-slip posts has a cross-section of a triangular, rectangular, pentagonal or polygonal shape.

5. The anti-slip fabric as claimed in claim 1, wherein the head of each of the anti-slip posts is partially curved.

6. The anti-slip fabric as claimed in claim 1, wherein the head of each of the anti-slip posts has a spherical shape.

7. The anti-slip fabric as claimed in claim 1, wherein the head and the body of each of the anti-slip posts are integrally formed with each other.

8. The anti-slip fabric as claimed in claim 1, wherein the fabric substratum and the anti-slip posts are integrally formed with each other.

9. The anti-slip fabric as claimed in claim 1, wherein the anti-slip posts have a same or different height relative to each other.

10. The anti-slip fabric as claimed in claim 1, wherein the anti-slip posts are evenly or unevenly arranged on the fabric substratum.

11. An insole comprising:
an insole substratum, and
an anti-slip fabric of claim 1, which is bonded on the insole substratum.

12. The insole as claimed in claim 11, wherein the head of each of the anti-slip posts has a cross-section of a triangular, rectangular, pentagonal or polygonal shape.

13. The insole as claimed in claim 11, wherein the head of each of the anti-slip posts is partially curved.

14. The insole as claimed in claim 11, wherein the head of each of the anti-slip posts has a spherical shape.
